(19) United States
(12) Patent Application Publication
(10) Pub. No.: US 2013/0330696 A1
(43) Pub. Date: Dec. 12, 2013

(54) Rotatable Robotic Manipulation Trainer Assembly

(71) Applicant: Mimic Technologies, Inc., Seattle, WA (US)

(72) Inventors: Jeffrey J. Berkley, Seattle, WA (US); David Alan Lopata, Covington, WA (US)

(21) Appl. No.: 13/915,576

(22) Filed: Jun. 11, 2013

Related U.S. Application Data
(60) Provisional application No. 61/658,151, filed on Jun. 11, 2012.

(51) Int. Cl. G09B 23/28

(52) U.S. Cl. CPC G09B 23/28
USPC 434/262

(57) ABSTRACT

A developmental robotic manipulation trainer assembly may include a housing assembly and a rotatable module carrier assembly for carrying robotic training exercise modules. The rotatable module carrier assembly may rotate about a spindle of the housing assembly. The rotatable module carrier assembly may include a number of dividers for separating the rotatable module carrier assembly into a number of regions. The dividers may be removable from the rotatable module carrier assembly. The developmental robotic manipulation trainer assembly may include a lock member for preventing rotation of the rotatable module carrier assembly.

### CROSS REFERENCE TO RELATED PATENT APPLICATIONS

The present patent application claims priority to U.S. Provisional Patent Application No. 61/658,151, filed Jun. 11, 2012, and titled “ROTATABLE ROBOTIC MANIPULATION TRAINER ASSEMBLY”. The disclosure of the above mentioned provisional patent application is herein incorporated by reference in its entirety.

### BACKGROUND

Robotic systems are used in a variety of applications such as, but not limited to, robotic assisted surgery and may be quite expensive. For example, surgical robotic systems may cost in the neighborhood of two million dollars.

Besides being expensive, robotic systems require that a user be properly trained in performing tasks and procedures with a robotic system. For example, it may take a skilled surgeon many hours of training to learn how to properly control/operate a surgical robotic system. Surgeons may learn how to control/operate a surgical robotic system by practicing to manipulate inanimate objects with robotic tools.

However, such training is costly. Each hour a surgeon is training to learn how to control/operate a surgical robotic system is an hour that the surgical robotic system is not being utilized to perform an actual surgical procedure for which the surgeon (and hospital) may be paid.

Apparatuses, techniques, and systems to decrease the amount of time that a user needs to practice on a robotic system are needed.

### BRIEF DESCRIPTION OF THE DRAWINGS

The detailed description is described with reference to the accompanying figures. The same reference numbers in different figures indicate similar or identical elements and/or features. The sizes and relative positions of elements in the drawings are not necessarily drawn to scale.

FIG. 1 is an isometric view of a developmental robotic manipulation trainer assembly according to one illustrated embodiment.

FIG. 2 is an isometric view of the developmental robotic manipulation trainer assembly of FIG. 1 with robotic training exercise module removed.

FIG. 3 is cross sectional view of the developmental robotic manipulation trainer assembly of FIG. 2.

FIG. 4 is an isometric view of a portion of a housing assembly according to one illustrated embodiment.

FIG. 5 is cross sectional view of the housing assembly of FIG. 4.

FIG. 6 is cross sectional view of a spindle according to one illustrated embodiment.

FIG. 7 is an exploded isometric view of a rotatable module carrier assembly according to one illustrated embodiment.

FIG. 8 is a top plan view of the rotatable module carrier assembly of FIG. 7.

FIG. 9 is a bottom plan view of the rotatable module carrier assembly of FIG. 7.

FIG. 10 is an isometric view of another developmental robotic manipulation trainer assembly according to one illustrated embodiment.

FIG. 11 is an isometric view of another developmental robotic manipulation trainer assembly according to another illustrated embodiment.

FIG. 12 is an isometric view of another developmental robotic manipulation trainer assembly according to one illustrated embodiment.

FIG. 13 is a top plan view of a supplemental platform according to one illustrated embodiment.

FIG. 14 is a top plan view of a supplemental platform according to another illustrated embodiment.

The headings and Abstract of the Disclosure provided herein are for convenience only and do not interpret the scope or meaning of the embodiments.

### DETAILED DESCRIPTION

### Overview

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with systems and methods for providing robotic control have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

### Overview

This disclosure provides techniques and systems to provide developmental training in manipulation of robotically controlled tools.

A developmental robotic manipulation trainer assembly may carry a plurality of robotic training exercise modules. A user of a robotic system may gain proficiency in controlling the robotic system by performing various tasks set out in the robotic training exercise modules carried on a rotatable platform.

When the user has completed tasks in a robotic training exercise module, the user may switch to another robotic training exercise module by rotating a platform in the developmental robotic manipulation trainer assembly. Switching between different robotic training exercise modules by rotating the platform is faster than pausing a training session to allow removal of a completed robotic training exercise module and placement of a new robotic training exercise module.

Further, in some instances, after the platform in the developmental robotic manipulation trainer assembly has been rotated—so as to expose a new robotic training exercise module to the user—the completed robotic training exercise module may be removed, from the developmental robotic manipulation trainer assembly, by an assistant, while the user practices on the new robotic training exercise module. Thus, any delay between ending one robotic training exercise module and starting a new robotic training exercise module may be limited to the time necessary for rotating the platform in the developmental robotic manipulation trainer assembly.

### Illustrative System

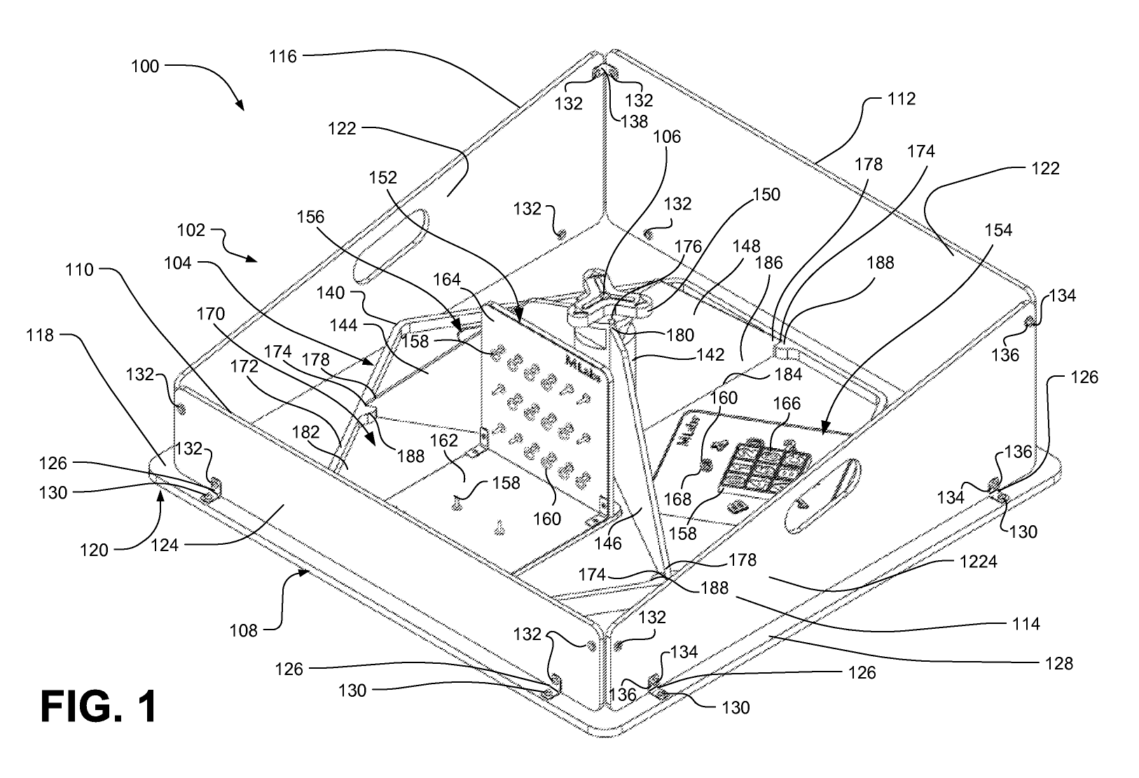

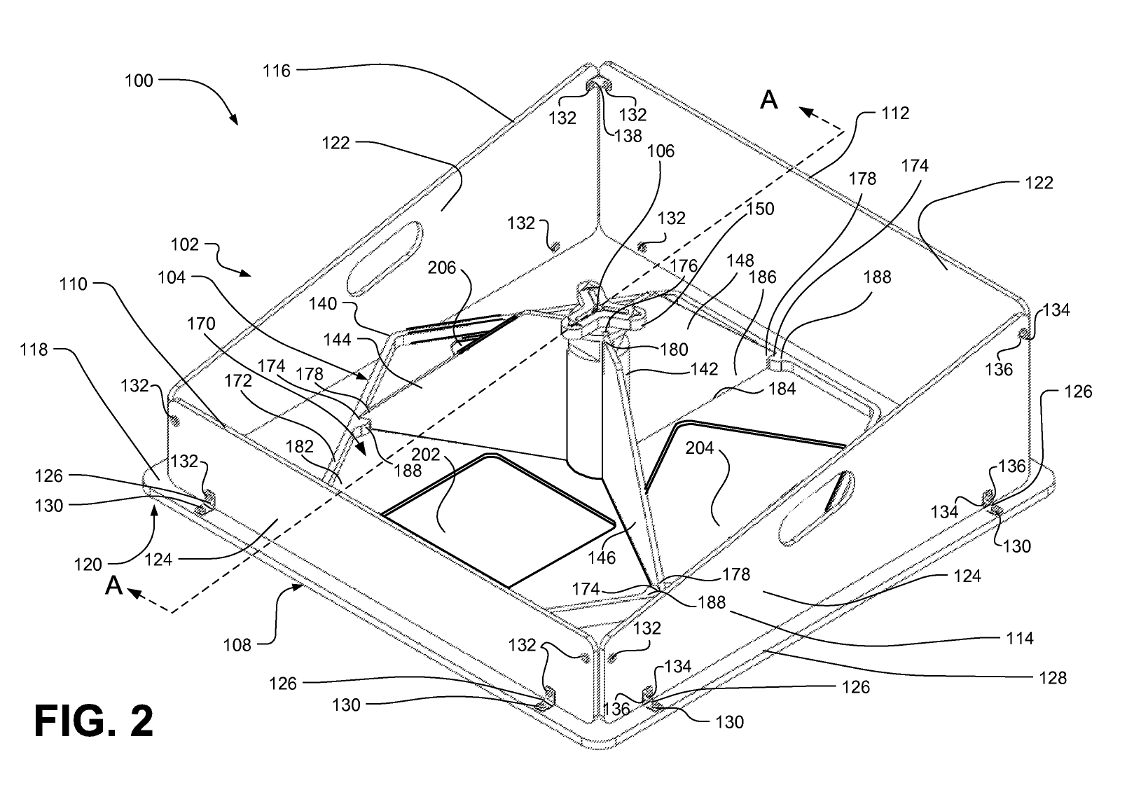

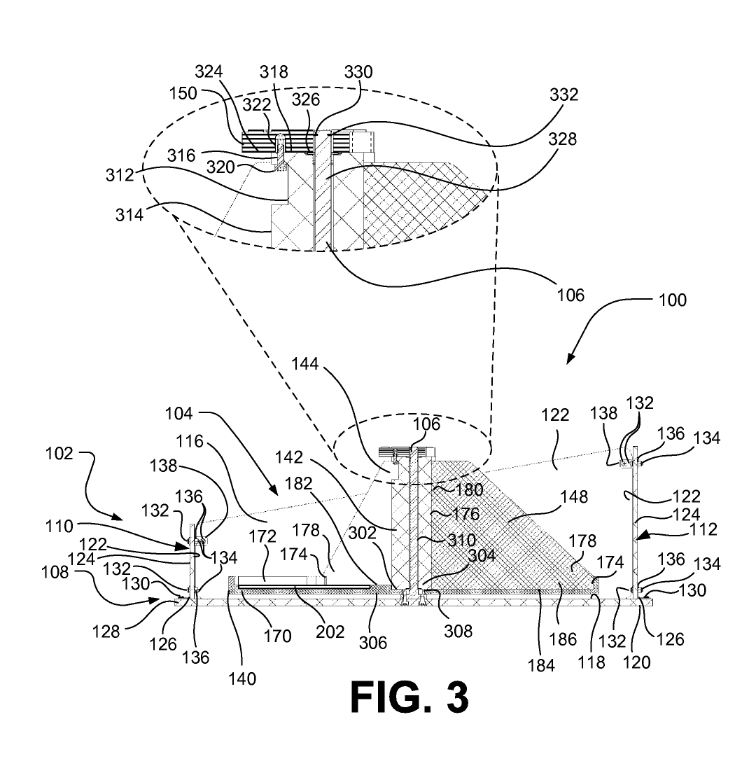

Aspects of a developmental robotic manipulation trainer assembly 100 are discussed below with respect to FIGS. 1-9, which illustrate various features and/or elements of the developmental robotic manipulation trainer assembly 100 from various points of view. FIG. 1 is an isometric view of the developmental robotic manipulation trainer assembly 100 having a housing assembly 102 and a rotatable module carrier assembly 104 carrying robotic training exercise modules 152-156, and FIG. 2 is an isometric view of the developmental robotic manipulation trainer assembly 100 with the robotic training exercise modules 152-156 removed for the sake of clarity. FIG. 3 is a cross sectional view of the developmental robotic manipulation trainer assembly 100 as viewed along line A-A shown in FIG. 2.

### Illustrative Housing Assembly

Referring to FIGS. 1-5, the housing assembly 102 may include spindle 106 about which the rotatable module carrier assembly 104 rotates, clockwise or counter-clockwise, and may include a base 108 and walls 110-116. The base 108 and walls 110-116 may be a generally rigid material such as a plastic material such as, but not limited to, acrylonitrile butadiene styrene (ABS), polyvinyl chloride (PVC), acrylic, plexiglass, polycarbonate, etc. In some embodiments, the walls 110-116 may be made from a translucent material or a transparent material, e.g., polycarbonate, while the base 108 may be made from a generally opaque material, e.g., ABS plastic. The base 108 may be generally a sheet, which may be generally planar, having a generally planar upper surface 118 and a bottom surface 120. The walls 110-116 may be generally planar having opposed inner and outer sides, 122 and 124, respectively.

The housing assembly 102 may include attachment devices 126, which may be disposed on the upper surface 118 of the base 108 proximal to a circumferential edge region 128. The attachment devices 126 may be coupled to the base 108 by fasteners 130. The attachment devices 126 may be configured to couple with the walls 110-116. In the illustrated embodiment, the attachment devices 126 are shown as being generally L-shaped brackets with a first arm engaging the upper surface 118 of the base 108 and a second arm engaging the outer side 124 of one of the walls 110-116. The walls 110-116 may be coupled to the attachment devices 126 by fasteners 132.

In the illustrated embodiment, fasteners 130 and/or fasteners 132 may be screws, bolts, rivets, etc. In some instances, the fasteners 130 may include threads that engage the base 108, and/or the fasteners 132 may include threads that engage one of the walls 110-116. In some instances, the fasteners 130 may be sized and shaped for extending through the attachment device 126 and the base 108 such that the fasteners 130 may mate with a corresponding coupler. For example, a fastener 130 may be a threaded screw or bolt and a coupler may have complimentary threads for mating with the threads of the fastener 130 (e.g., the coupler may be a nut). Similarly, in some instances, the fasteners 132 may be sized and shaped for extending through the attachment device 126 and one of the walls 110-116 such that the fasteners 132 may mate with a corresponding coupler. For example, the fasteners 132 may have a threaded end 134 that extends past one of the walls 110-116 such that a coupler 136, such as, but not limited to, a nut, may mate with the threaded end 134.

Attachment devices 138 may be disposed on the inner side 122 of the walls 110-116 such that each one of the attachment devices 138 engages a respective pair of the walls 110-116, e.g., walls 112 and 114 may form a pair of walls engaged by one or more attachment devices, walls 112 and 116 may form another pair of walls engaged by one or more attachment devices 138, walls 110 and 114 may form another pair of walls engaged by one or more attachment devices, and walls 110 and 116 may form another pair of walls engaged by one or more attachment devices. The attachment devices 138 may be coupled to the walls 110-116 via fasteners 132, which may include a threaded end 134 that may engage a corresponding coupler 136. In some instances, an attachment device(s) 138 may be disposed on the outer side 124 of the of the walls 110-116 such that each one of the attachment devices 138 engages a respective pair of the walls 110-116, e.g., walls 112 and 114, walls 112 and 116, walls 110 and 114, and walls 110 and 116. In some embodiments, attachment devices 138 may include generally L-shaped brackets having openings through which portions of the fasteners may extend therethrough.

Wall 110 may define a front user side of the developmental robotic manipulation trainer assembly 100 and may extend generally upward from the base 108 by a height (h1). Wall 112 may define a rear user side of the developmental robotic manipulation trainer assembly 100 and may extend generally upward from the base 108 by a height (h2), where the height (h2) of the wall 112 may be greater than the height (h1) of the wall 110. The walls 114 and 116 may have heights that are non-uniform and which may vary between heights h1 and h2. Typically, the height (h1) of the wall 110 is such that the wall 110 does not impede access and/or visibility to the rotatable module carrier assembly 104.

In some embodiments, the height (h1) of the wall 110 may be in the range of approximately ¼ to ¾ of the height (h2) of the wall 112.

In some embodiments, the height (h1) of the wall 110 may be less than the height (h2) of the wall 112, and the walls 114 and 116 may have heights vary linearly between a minimum height of approximately h1 and a maximum height of approximately h2.

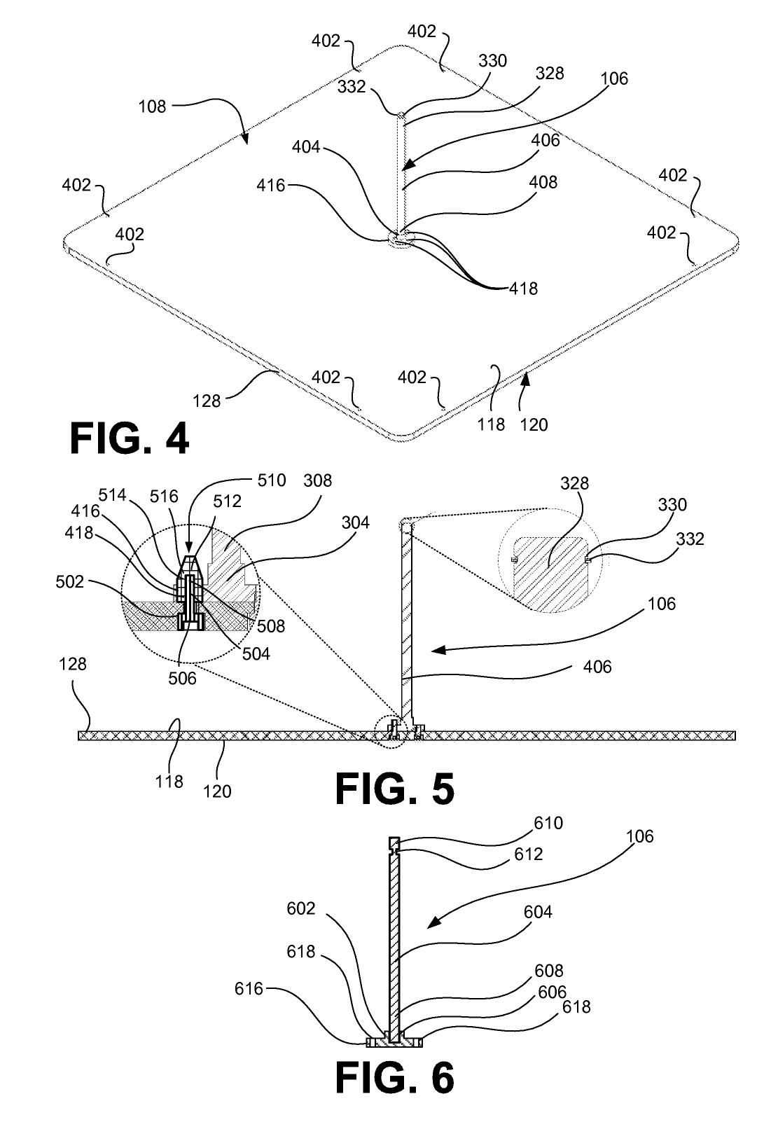

Referring to FIG. 4, the base 108 may include a plurality of couplers 402 configured to receive the fasteners 130. In some instances, the couplers 402 may be holes, which may be threaded or non-threaded and which may extend at least partially, or completely, between the upper and bottom surfaces, 118 and 120, respectively, of the base 108. In some instances, the fasteners 130 may be threaded screws or bolts or the like and the couplers 402 may include nuts that may be disposed on the bottom surface 120 of the base 108 and/or may include nuts that may be disposed at least partially between the upper and bottom surfaces, 118 and 120, respectively, of the base 108.

Referring to FIGS. 2-4, the spindle 106 may be affixed to the base 108 by an adhesive or cement or by fasteners. In some instances, the spindle 106 may be removably coupled to the base 108. The spindle 106 may include a mount 404 and an elongated member 406. The elongated member 406 may be generally cylindrical in shape and may include a first end 408 proximal to the mount 404 and a second end 328 (see FIG. 3) distal from the mount 404. The second end 328 may include a recess 330. The recess 330 may circumscribe the elongated member 406 and may be sized and shaped to receive a stop 332 such as a snap ring. In some embodiments, the mount 404 and the elongated member 406 may be integrally formed, e.g., the spindle 106 may be formed as a single unit such as a plastic unit formed by an extrusion process, or molding process, etc.

The mount 404 may include a flange 416. The flange 416 may include mount couplers 418, which may be holes, threaded or non-threaded, that may extend through the flange 416.

Referring to FIG. 5, the base 108 may include openings 502. Openings 502 may extend between the upper and bottom surfaces, 118 and 120, of the base 108 and may be threaded or non-threaded. In some instances, openings 502 may be tapered, countersunk, etc. When the spindle 106 is located in operable position, the openings 502 may be aligned with the mount couplers 418.

The openings 502 and the mount couplers 418 may be sized and shaped to receive fasteners 504, which may include a corresponding first and second ends 506 and 508, respectively. Fasteners 504 may extend at least partially through the base 108 and at least partially through the flange 416 of the mount 404 and may be, among other things, screws, bolts, rivets, etc. In some instances, fasteners 504 may extend beyond flange 416. Fasteners 504 may be mated to mount couplers 418 to affix the spindle 106 to the base 108.

Referring to FIG. 5, the housing assembly 102 may include a lock member 510. When the rotatable module carrier assembly 104 is located in operable position, the lock member 510 may engage the rotatable module carrier assembly 104 to prevent rotation of the rotatable module carrier assembly 104 about the spindle 106. The lock member 510 may have an upper portion 512, side walls 514, and a chamfered portion 516 extending between the upper portion 512 and the side walls 514. In some instances, at least one of the fasteners 504 may be sized such that the second end 508 may extend beyond the flange 416 and the lock member 510 may be disposed on the second end 508. In some instances, the lock member 510 may be a nut or a cover for the second end 508.

In some instances, the lock member 510 may be integral with the fastener 504. For example, the lock member 510 may be at least a portion of the second end 508 that extends beyond the flange 416.

In some embodiments, at least a portion of the spindle 106 may have a non-circular cross section, e.g., a portion of the spindle 106 may be triangular, rectangular, square, oval, star shaped, etc. For example, at least a portion of the first end 408 of the elongated member 406 may have a non-circular cross section. In such embodiments, the rotatable module carrier assembly 104 may include a member that is complementarily sized and shaped for receiving and engaging the first end 408 of the elongated member 406. The non-circular cross section portion of the elongated member 406 may be a lock mechanism that prevents accidental, inadvertent rotations of the rotatable module carrier assembly 104 about the spindle 106. In such embodiments, the rotatable module carrier assembly 104 may be purposefully rotated about the spindle 106 by lifting the rotatable module carrier assembly 104 upward to a height such that the rotatable module carrier assembly 104 no longer engages the non-circular cross section portion of the elongated member 406. The shape of the non-circular cross section may be selected such that the rotatable module carrier assembly 104 may be locked into a predetermined orientation with respect to the housing assembly 102. For example, if the non-circular cross section portion of the elongated member 406 has a shape of an equilateral triangle, then the rotatable module carrier assembly 104 may be locked into three different orientations.

In the embodiment illustrated in FIG. 5, fasteners 504 extend generally upward from the base 108 to the mount 404. However, in other embodiments, the fasteners 504 may extend generally downward. In such embodiments, a mount coupler 418 may be sized and shaped to receive the first end 506 of a fastener 504, and a corresponding opening 502, which may be threaded or non-threaded, may be sized and shaped to receive the second end 508 of the fastener 504.

In embodiments in which one or more of the fasteners 504 extend generally downward, one or more of the fasteners 504 may be positioned with at least a portion of their respective first ends 506 extending above the flange 416. The first ends 506 of these fasteners 504 may be sized and shaped to be lock members 510.

Referring to FIG. 6, in some embodiments, the spindle 106 may include a mount 602 and an elongated member 604. The mount 602 may include an opening 606. The elongated member 604 may include a first end 608 and a second end 610. The second end 610 may include a recess 612. The recess 612 may be sized and shaped to receive the stop 332 (see FIG. 4) such as a snap ring.

The mount 602 may include a flange 616. The flange 616 may include mount couplers 618, which may be holes, threaded or non-threaded, that may extend through the flange 616.

The opening 606 may be sized and shaped to receive the first end 608 of the elongated member. In some instances, the mount 602 and the elongated member 604 may be coupled together by pressure fitting. In other instances, the mount 602 and the elongated member 604 may be coupled together by an adhesive or cement.

In the embodiment illustrated in FIG. 5, the spindle 106 is illustrated as being coupled to the upper surface 118 of the base 108. However, in some embodiments, base 108 may be configured with an opening that receives the elongated member 406 such that the spindle 106 may be coupled to the bottom surface 120 of the base 108.

The spindle 106 may be a generally rigid material such as a plastic material such as, but not limited to, acrylonitrile butadiene styrene (ABS), polyvinyl chloride (PVC), acrylic, plexiglass, polycarbonate, etc.

### Illustrative Rotatable Module Carrier Assembly

Referring to FIGS. 1-3 and 7-9, the rotatable module carrier assembly 104 may include a platform 140, a post 142, dividers 144-148, and a handle 150, which may be made from a generally rigid material such as a plastic material such as, but not limited to, acrylonitrile butadiene styrene (ABS), polyvinyl chloride (PVC), acrylic, plexiglass, polycarbonate, etc. The rotatable module carrier assembly 104 is configured to rotate about the spindle 106, which extends through the post 142 between the base 108 and the handle 150.

The dividers 144-148 extend radially outward from the post 142. In the illustrated embodiment, there are three dividers 144-148, which may be spaced to have an approximate angular separation of 120 degrees such that the platform 140 is divided into three regions (e.g., dividers 144 and 146 define region I, dividers 146 and 148 define region II, and dividers 148 and 144 define region III) having approximately equal area. In other embodiments, the number of dividers may be greater or smaller (even zero), and the dividers, if any, may be disposed with uneven angular separation.

A robotic training exercise module 152-156 is disposed in regions I-III, respectively, and may include a number of targets 158 and a number of movable training pieces 160. A user may develop proficiency in operating a robot (not shown) by using a robotic tool (not shown) to grip a movable training piece 160 and place the movable training piece on a desired target 158.

In the illustrated embodiment, the robotic training exercise module 152 includes a support member 162 and back member 164. The support member 162 may be disposed on the platform 140 may include targets 158, which are illustrated as pegs extending generally vertically upward from the support member 162. The back member 164 may extend generally vertically upward from the support member 162 and may include targets 158, which are illustrated as pegs extending generally horizontally from the back member 164. A user may practice controlling a robot (not shown) by moving the movable training pieces 160, which are illustrated as rings, from one target 158 to another target 158.

In the illustrated embodiment, the robotic training exercise module 154 may include targets 158, which are illustrated as three-dimensional outlines 166 (e.g., shaped recesses), and may include movable training pieces 160, which may include three-dimensional shapes 168 that generally correspond to the three-dimensional outlines 166. A user may practice controlling a robot (not shown) by moving a three-dimensional shape 168 such that it is properly aligned with the corresponding three-dimensional outline 166 and placing the three-dimensional shape 168 into the corresponding three-dimensional outline 166.

The movable training pieces 160 may be elastic, and when a user attempts to grip one of the movable training pieces with a tool of a robot (not shown), the tool may deform (e.g., stretch) the movable training piece 160. If the user does not have a good grip on the deformed movable training piece 160, the movable training piece 160 may fly or slip out of the tool of the robot (not shown). Similarly, the may drop, bump, mishandle, etc. the movable training pieces 160 when employing the developmental robotic manipulation trainer assembly 100. The dividers 144-148 are sized and positioned as back stops to prevent the accidental inter-regional movement of the movable training pieces 160 (i.e., prevent a movable training piece 160 in region I from accidentally traversing into region II).

The platform 140 may include a support member 170 having a circumferential edge region 172 that extends generally upward from the support member 170. The circumferential edge region 172 may be sized and shaped to have sufficient height (relative to the support member 170) to contain movable training pieces 160 within the rotatable module carrier assembly 104. For example, the height of the circumferential edge region 172 may be sufficient height to prevent a ring shaped movable training piece 160 from rolling out of the rotatable module carrier assembly 104.

In the illustrated embodiment, the circumferential edge region 172 is shown as a hexagonal shape. However, in other embodiments, the circumferential edge region 172 may have other shapes such as, but not limited to, circular, triangular, square, octagonal, etc.

The circumferential edge region 172 and the post 142 define a number of slots 174 and 176, respectively. The slots 174 may be sized and shaped to receive at least a portion of an outer-end 178 of a corresponding divider 144-148, and the slots 176 may be sized and shaped to receive at least a portion of an inner-end 180 of a corresponding divider 144-148.

The support member 170 may have an upper surface 182, which may define a number of grooves 184 that may extend radially outward to the slots 174. The grooves 184 may be sized and shaped to receive at least a portion of a bottom edge 186 of a corresponding divider 144-148. In some embodiments, the dividers 144-148 may be removably coupled to rotatable module carrier assembly 104 via slots 174 and 176 and grooves 184. In some instances, the dividers 144-148 may be removed from the rotatable module carrier assembly 104 by sliding the dividers 144-148 upward and out of slots 174 and 176 and grooves 184.

The circumferential edge region 172 may define a number of tabs 188. The tabs 188 may protrude inward from the circumferential edge region 172 and may define the slots 174.

In some embodiments, the dividers 144-148 may be fixedly coupled to rotatable module carrier assembly 104. In some instances, the dividers 144-148 may be pressure fit into the slots 174 and 176 and grooves 184. In some instances, the dividers 144-148 may be adhered into the slots 174 and 176 and grooves 184 with adhesive, cement, etc.

Referring to FIGS. 2, 3, 7 and 8, the platform 140 may include bays 202-206, which may be recesses in the upper surface 182 of the platform 140. The bays 202-206 are sized and shaped to receive the robotic training exercise module 152-156. The bays 202-206 prevent the robotic training exercise modules 152-156 from slipping when the rotatable module carrier assembly 104 is rotated.

Referring to FIGS. 3, 7 and 8, the upper surface 182 of the platform 140 may include a recess 302 sized and shaped to receive a bottom portion 304 of post 142. The post 142 may be affixed to the platform 140 by pressure fitting the bottom portion 304 of the post 142 into the recess 302 and/or by an adhesive or cement.

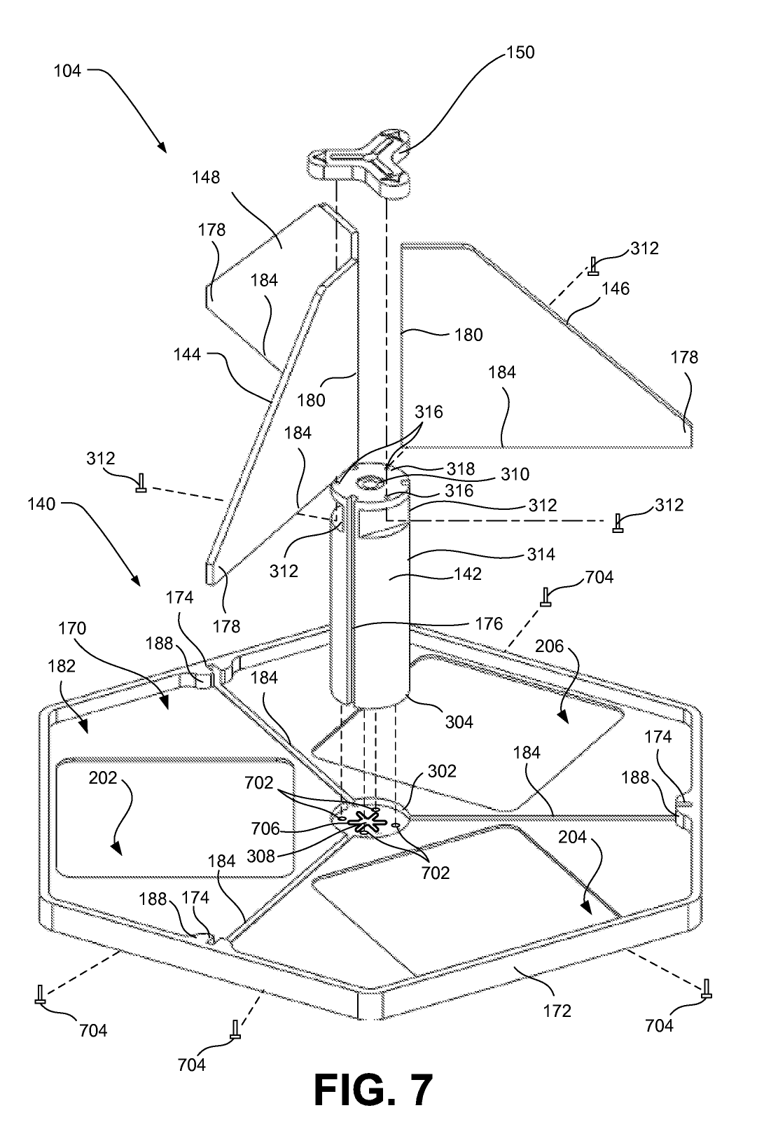

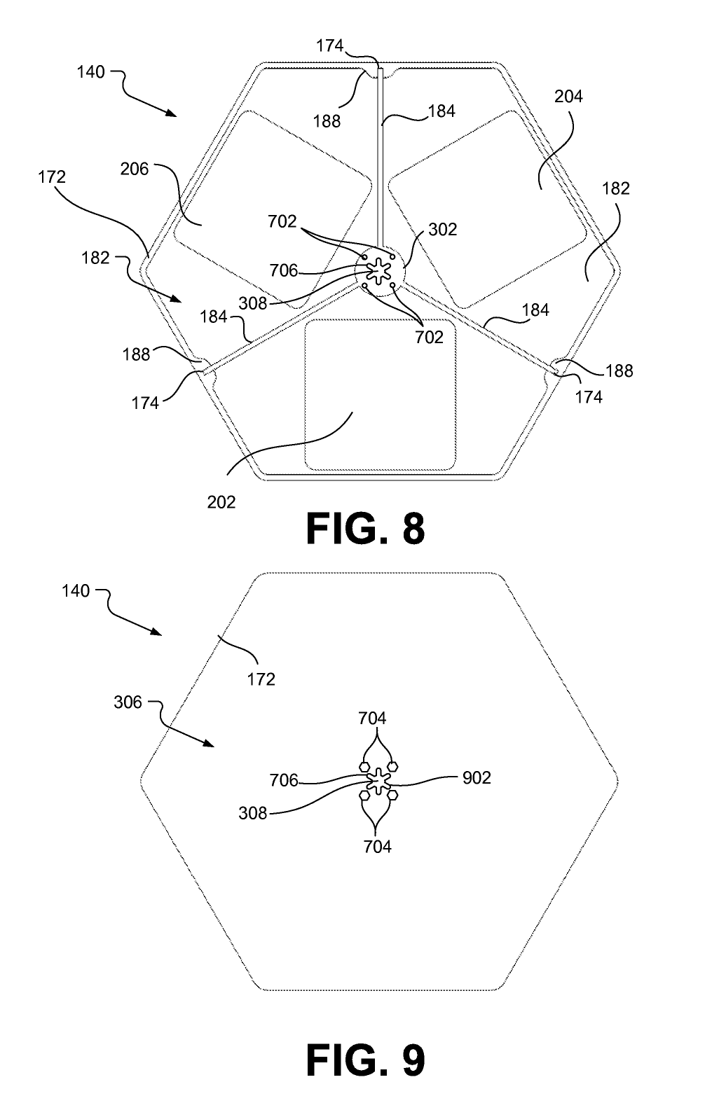

In some embodiments, a number of openings 702 (see FIGS. 7, 8) may extend from a bottom surface 306 (see FIG. 3) of the platform 140. The openings 702 may be sized and shaped to receive fasteners 704 (see FIGS. 7, 9). Fasteners 704 may extend upward from the bottom surface 306 of the platform 140 and beyond the upper surface 182 of the recess 302 of the platform 140 such that the fasteners 704 may engage post couplers (not shown) of the post 142. The fasteners 704 and the post couplers (not shown) may be aligned and mated together to affix the post 142 to the platform 140. In some instances, fasteners 704 may include screws and/or bolts and post couplers (not shown) may include openings and/or nuts to mate with the fasteners 704.

The upper surface 182 of the platform 140 may include an opening 308 (see FIG. 3) sized and shaped to receive the spindle 106. The opening 308 extends between the upper surface 182 of the platform 140 and the bottom surface 306 of the platform 140. The opening 308 may include a number of slots 706 (see FIG. 7) that extend radially outward. The slots 706 may be sized and shaped to receive the lock member 510.

In the illustrated embodiment, the number of slots 706 is six and they are spaced with an approximate angular separation of sixty (60) degrees. Proximal to the bottom surface 306 of the platform 140, the slots 706 may have a chamfered region 902. The chamfered region 902 may match the chamfered portion 516 of the lock member 510. The chamfered region 902 and the chamfered portion 516 facilitate alignment of the slots 706 with the lock member 510.

The post 142 may include a spindle opening 310 (see FIG. 3) that may extend through the post 142. The spindle opening 310 may be sized and shaped to receive the spindle 106. The spindle opening 310 may be approximately aligned with a center axis of the post 142.

The post 142 may also include recesses 312 that may be formed in an exterior wall 314 of the post 142. Openings 316 may extend between the recesses 312 and an upper surface 318 of the post 142. The recesses 312 may be sized and shaped to enable fasteners 320 to be placed into the openings 316.

Referring to FIG. 3, the handle 106 may include handle couplers 322 disposed and/or formed in a bottom surface 324 of the handle 150. The handle couplers 322 may be openings, threaded or non-threaded, for mating with fasteners 320. The handle 150 may be affixed to the post 142 by aligning the handle couplers 322 with the openings 316 and inserting fasteners 320 into the openings 316 to mate with the handle couplers 322. In some embodiments, the handle 150 may be affixed to the post 142 via an adhesive or cement.

The handle 150 may be sized and shaped to permit free access to the slots 176 when the handle 150 is coupled to the post 142. In such a configuration, the handle 150 may remain coupled to the post 142 while the dividers 144-148 are removed/inserted into the slots 176.

The rotatable module carrier assembly 104 may be a rigid structure such that the rotatable module carrier assembly 104 may be manually raised, rotated, and lowered by a user gripping/manipulating the handle 150. A slidable member 326 may be positioned interposing the post 142 and the handle 150. The slidable member 326 may be a washer or similar element. In operable position, the slidable member 326 fits around the spindle 106 and is separated from the stop 332 by a travel distance. When the rotatable module carrier assembly 104 is raised (and lowered), the slidable member 326 is raised (and lowered) with the post 142. The slidable member 326 and the stop 332 are configured to engage each other when the rotatable module carrier assembly 104 is raised the travel distance so as to prevent the rotatable module carrier assembly 104 from being removed from the spindle 106 when a user is attempting to rotate the rotatable module carrier assembly 104. The travel distance of the slidable member 326 is sufficient distance to raise the bottom surface 306 of the platform 140 away from the lock member 510 such that the lock member 510 is disengaged the bottom surface 306 of the platform 104 so as permit rotation of the rotatable module carrier assembly 104.

### Other Illustrative Systems

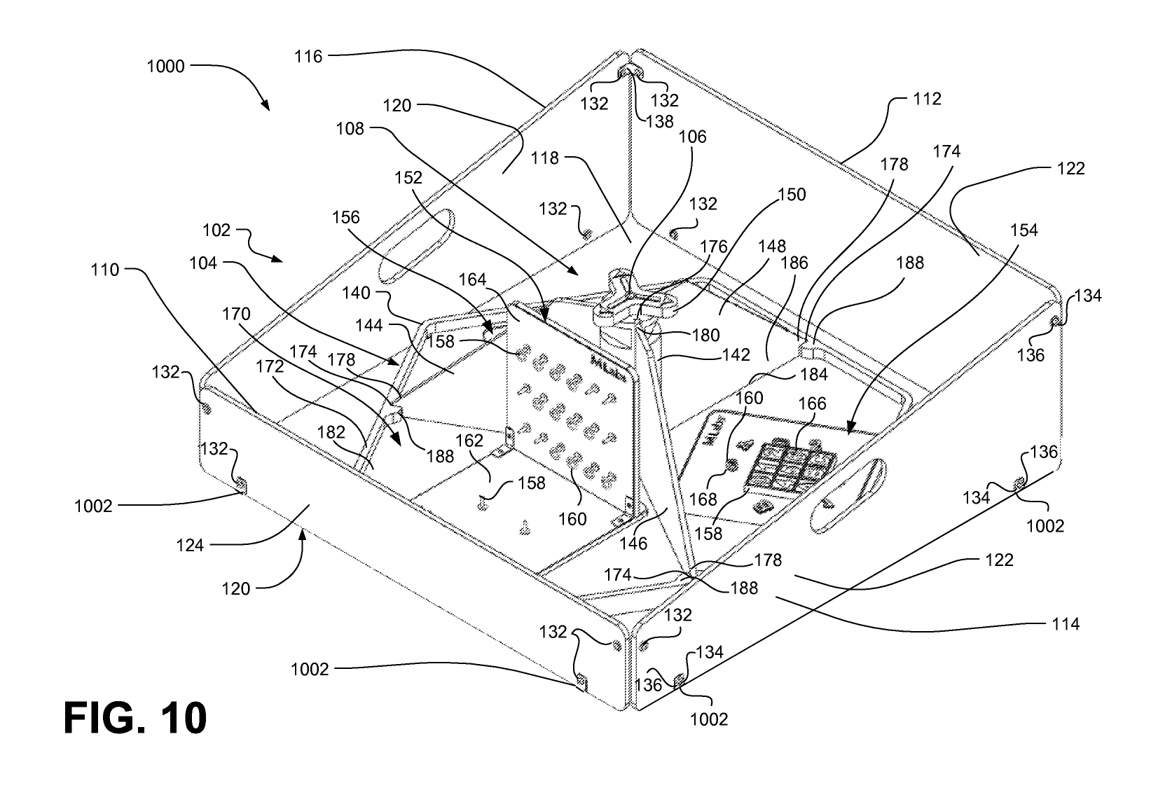

FIG. 10 is an isometric view of a developmental robotic manipulation trainer assembly 1000 according to one illustrated embodiment. In this embodiment, walls 110-116 are coupled to circumferential edge of the base 108 via fasteners 1002. Fasteners 1002 may be generally L-shaped brackets with one arm coupled to the bottom surface 120 of the base 108 and another arm coupled to one of the walls 110-116.

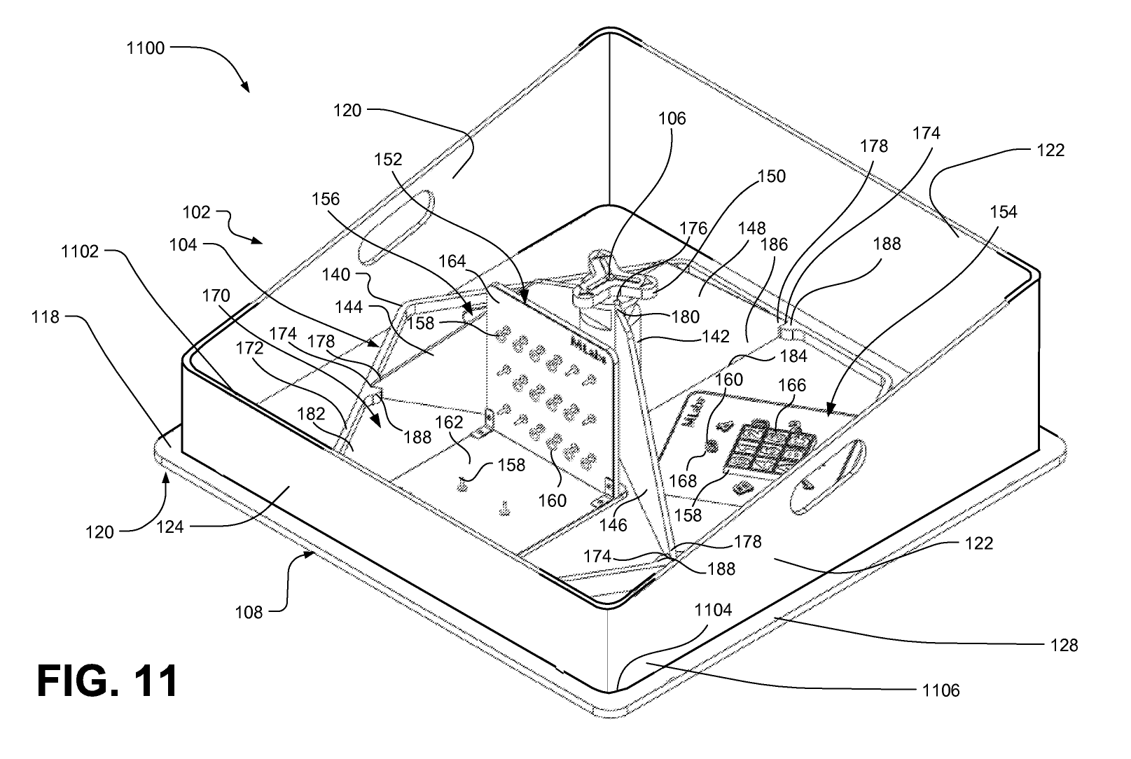

FIG. 11 is an isometric view of a developmental robotic manipulation trainer assembly 1100 according to one illustrated embodiment. In this embodiment, walls 110-116 may be replaced with an integral wall 1102. The base 108 may define a groove 1104 that may be formed proximal to the circumferential edge region 128. The groove 1104 may be sized and shaped to receive a bottom portion 1106 of the wall 1102. The wall 1102 and the base 108 may be coupled together by pressure fitting the bottom portion 1104 of the wall 1102 into the groove 1104. In some instances, the wall 1102 and the base 108 may be coupled together by an adhesive or cement.

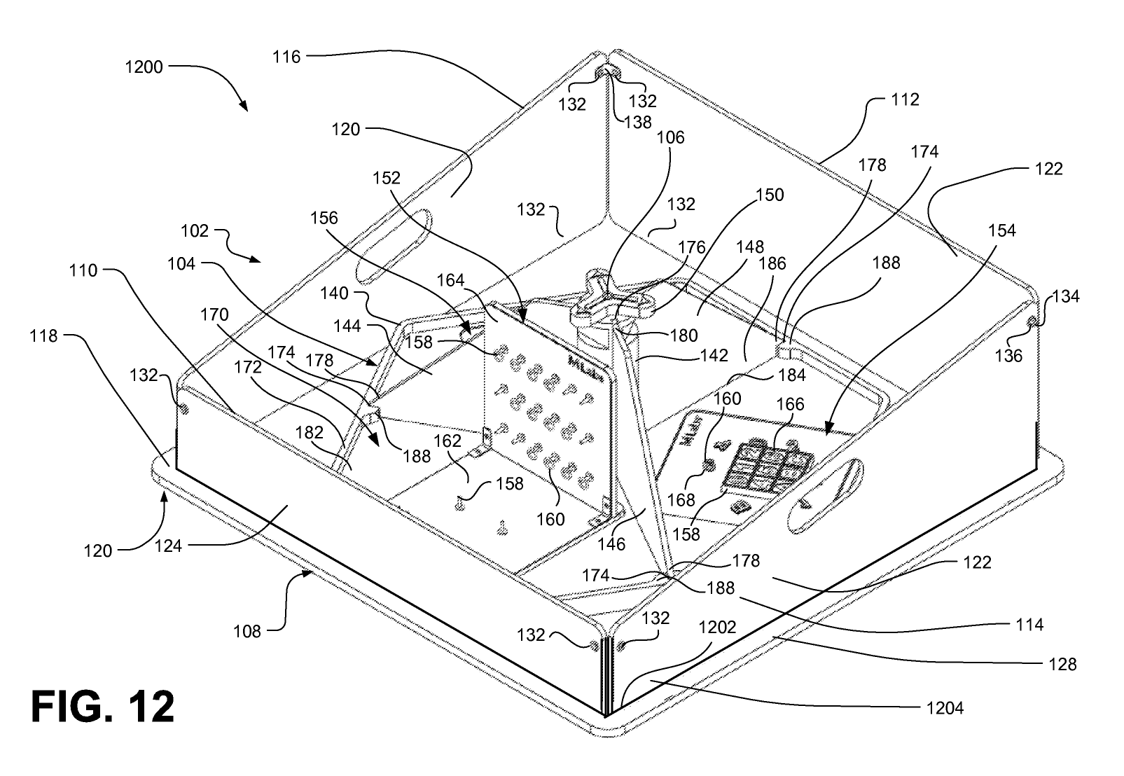

FIG. 12 is an isometric view of a developmental robotic manipulation trainer assembly 1200 according to one illustrated embodiment. In this embodiment, the base 108 may define a groove 1202 that may be formed proximal to the circumferential edge region 128. The groove 1202 may be sized and shaped to receive a bottom portion 1204 of the walls 110-116. The walls 110-116 and the base 108 may be coupled together by pressure fitting the bottom portion 1204 of the walls 110-116 into the groove 1202. In some instances, the walls 110-116 and the base 108 may be coupled together by an adhesive or cement.

### Illustrative Supplemental Platforms

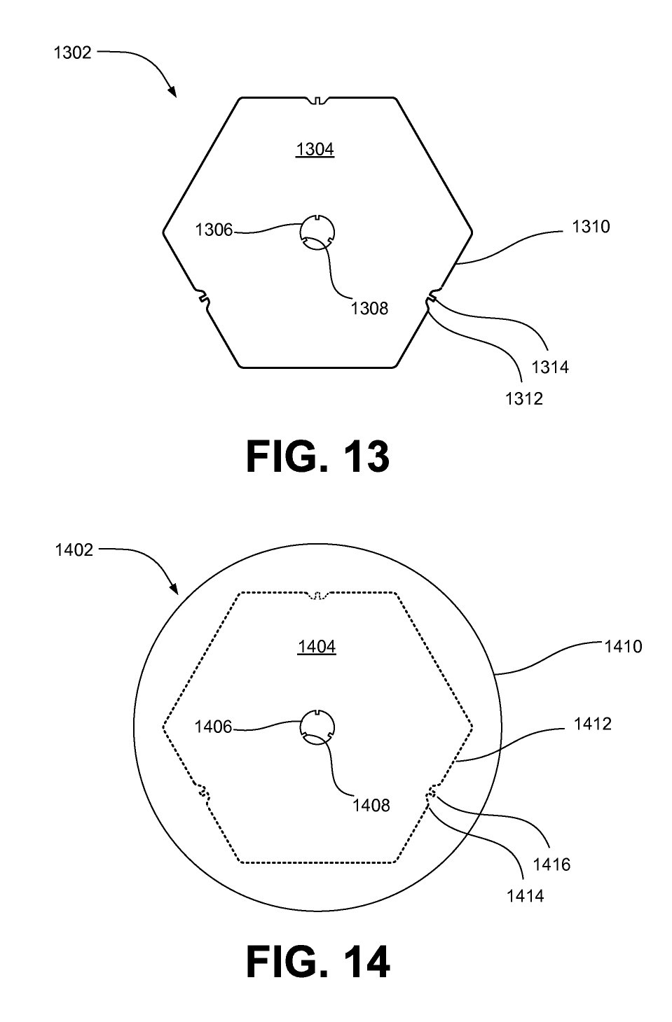

FIG. 13 is a plan view of a supplemental platform 1302. The supplemental platform 1302 may be positioned on the platform 140 and may provide a generally flat upper surface 1304. The supplemental platform 1302 may be used when robotic training exercise modules do not fit in the bays 202-206 and/or when a user desires to place more robotic training exercise modules in the rotatable module carrier assembly 104 than the number of bays 202-206. In such instances, desired training exercise modules may be placed on the upper surface 1304 of the supplemental platform 1302.

The supplemental platform 1302 may include an opening 1306 that is sized and shaped to fit around the post 142. The opening 1306 may include a number of tabs 1308. The tabs 1308 may be sized and shaped and spaced for being received by the slots 176 of the post 142. In some instances, the opening 1304 and the handle 150 may be sized such that the supplemental platform 1302 may fit over the handle 150.

The supplemental platform 1302 may include an outer edge 1310. The outer edge 1310 may be sized and shaped to be received by the circumferential edge region 172 of the platform 140. In some instances, the outer edge 1310 of the supplemental platform 1302 may define a number of recesses 1312. The recesses 1312 may be sized, shaped, and spaced to be complimentary to the tabs 188. In some instances, the recesses 1312 may include tabs 1314 which may be sized and shaped for being received by the slots 174.

FIG. 14 is a plan view of a supplemental platform 1402. The supplemental platform 1402 may be positioned on the platform 140 and may provide a generally flat upper surface 1404. The supplemental platform 1402 may be used when robotic training exercise modules do not fit in the bays 202-206 and/or when a user desires to place more robotic training exercise modules in the rotatable module carrier assembly 104 than the number of bays 202-206. In such instances, desired training exercise modules may be placed on the upper surface 1404 of the supplemental platform 1402.

The supplemental platform 1402 may includes an opening 1406 that is sized and shaped to fit around the post 142. The opening 1406 may include a number of tabs 1408. The tabs 1408 may be sized and shaped and spaced for being received by the slots 176 of the post 142. In some instances, the opening 1406 and the handle 150 may be sized such that the supplemental platform 1302 may fit over the handle 150.

The supplemental platform 1402 may include an outer edge 1410. In operable position, the outer edge 1410 may be sized and shaped to overhang the platform 140. The supplemental platform 1402 may provide a larger work area than the platform 140. In some instances, a bottom surface (not shown) of the supplemental platform may include a flange 1412 that may extend downward from the bottom surface and which may be complimentary to the circumferential edge region 172 of the platform 140. The flange 1412 may define a number of recesses 1414, which may be sized, shaped, and spaced to be complimentary to the tabs 188. In some instances, the recesses 1414 may include tabs 1416 which may be sized and shaped for being received by the slots 174.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A developmental robotic manipulation trainer assembly, comprising:
a housing defining a front user side, a rear side, a left side and a right side, the housing having a base, a spindle extending generally upward from an upper surface of the base at an approximate center of the base, and at least one wall circumscribing an outer peripheral region of the base, wherein the at least one wall has an upper end that is distal from the base and is a non-uniform height displaced therefrom, wherein the height of the at least one wall proximal to the front user side is less than the height of the at least one wall proximal to the rear side, wherein the at least one wall is sized and shaped to provide an opening for at least one robotic tool; and
a platform configured to be rotatable about the spindle and having a generally planar upper surface, the upper surface of the platform configured to receive at least one robotic training exercise module thereon;
a post coupled to the platform, the post having an elongated length with an opening extending at least partially therethrough, wherein the opening is configured to receive at least a portion of the spindle;
a first number of dividers removably coupled to at least one of the platform and the post, the first number of dividers configured to partition the platform into a second number of regions, the first number and the second number being the same, and wherein each region is configured one of the robotic training exercise modules; and
a lock mechanism configured to engage and disengage the platform, wherein the lock mechanism prevents rotation of the platform when the lock mechanism engages the platform.

2. The developmental robotic manipulation trainer assembly of claim 1, wherein the post is configured to slide along the spindle a free travel distance, and further comprising:
a handle coupled to an upper end of the post, wherein the handle, the post, the platform and the first number of dividers move as one while the post is slid along the spindle; and
a stop mechanism configured to engage at least one of the post and the spindle after the post has slid the free travel distance along the spindle;
and wherein while the post has been slid, away from the base, the free travel distance along the spindle, the lock mechanism is disengaged from the platform.

3. The developmental robotic manipulation trainer assembly of claim 1, wherein the elongated length of the post has an exterior surface that defines a third number of slots, and wherein the platform defines a circumferential edge region that defines a fourth number of slots, wherein the third and the fourth numbers are the same as the first number, wherein each slot of the elongated length is configured to receive at least a portion of an inner end of a respective one of the dividers, and wherein each slot of the circumferential edge region is configured to receive at least a portion of an outer end of a respective one of the dividers.

4. The developmental robotic manipulation trainer assembly of claim 1, wherein the upper surface of the platform defines a third number of bays, each bay configured to receive at least partially therein a respective one of the robotic training exercise modules, wherein the bays prevent the robotic training exercise modules from slipping while the platform is rotated about the spindle.

5. The developmental robotic manipulation trainer assembly of claim 1, wherein the lock mechanism is configured to lock the platform at predetermined rotations about the spindle such that at each predetermined rotation a respective one of the second number of regions is positioned proximal to the front user side of the housing.

6. A developmental robotic manipulation trainer assembly, comprising:
a housing having a base and a spindle extending generally upward from an upper surface of the base;
a rotatable module carrier assembly configured to rotate about the spindle and having a platform with a generally planar upper surface, the upper surface of the platform configured to receive at least one robotic training exercise module thereon; and
a lock mechanism configured to engage and disengage the rotatable module carrier assembly, wherein the lock mechanism prevents rotation of the rotatable module carrier assembly when the lock mechanism engages the rotatable module carrier assembly.

7. The developmental robotic manipulation trainer assembly of claim 6, further comprising:
a post configured to be rotatable about the spindle, the post extending generally upward from the upper surface of the platform and having an elongated length with an opening extending at least partially therethrough, wherein the opening is configured to receive at least a portion of the spindle.

8. The developmental robotic manipulation trainer assembly of claim 7, wherein the post is configured to slide a free travel distance along at least a portion of the spindle, and further comprising:
a stop mechanism configured to engage at least one of the post and the spindle after the post has slid the free travel distance along the spindle.

9. The developmental robotic manipulation trainer assembly of claim 8, wherein the lock mechanism is disengaged from the rotatable module carrier assembly when the post has slid the free travel distance along the spindle.

10. The developmental robotic manipulation trainer assembly of claim 6, further comprising:
at least two dividers, the dividers configured to partition the upper surface of the platform into at least two regions, each region being configured to receive a respective a robotic training exercise module therein.

11. The developmental robotic manipulation trainer assembly of claim 6, further comprising:
a number dividers, the dividers configured to partition the upper surface of the platform into a number regions, each region being configured to receive a respective a robotic training exercise module therein; and
a post extending generally upward from the upper surface of the platform and having an elongated length with an exterior surface, the exterior surface defining a number of slots, wherein the number of slots, the number of dividers, and the number of regions are the same number, and wherein each slot is configured to receive at least a portion of an inner end of a respective one of the dividers.

12. The developmental robotic manipulation trainer assembly of claim 11, wherein the upper surface of the platform defines a number of grooves extending radially outward from a point of rotation, wherein the number of grooves is the same as the number of slots of the post, and wherein each groove is configured to receive at least a portion of a bottom edge of a respective one of the dividers.

13. The developmental robotic manipulation trainer assembly of claim 11, wherein the platform defines a circumferential edge region that defines a number of slots, wherein the number of slots of the circumferential edge region is the same as the number of slots of the post, and wherein each slot is configured to receive at least a portion of an outer end of a respective one of the dividers.

14. The developmental robotic manipulation trainer assembly of claim 6, wherein a bottom surface of the platform defines a number of openings, and wherein the lock mechanism includes a lock member that is sized and shaped to be received by at least one of the number of openings of the bottom surface.

15. The developmental robotic manipulation trainer assembly of claim 14, wherein the number of openings of the bottom surface include a chamfered region, and wherein the lock member includes a chamfered portion that is complementary to the chamfered regions of the number of openings of the bottom surface.

16. A developmental robotic manipulation trainer assembly, comprising:
a housing having a base, a spindle extending generally upward from an upper surface of the base, at least one wall circumscribing an outer peripheral region of the base; and
a platform having a generally planar upper surface, the upper surface of the platform configured to receive at least one robotic training exercise module thereon;
a post coupled to the platform, the post configured to be rotatable about the spindle and having an elongated length with an opening extending at least partially therethrough, wherein the opening is configured to receive at least a portion of the spindle; and
a first number of dividers coupled to at least one of the platform and the post, the first number of dividers configured to partition the platform into a second number of regions, the first number and the second number being the same, and wherein each region is configured one of the robotic training exercise modules.

17. The developmental robotic manipulation trainer assembly of claim 16, wherein the post is configured to slide along the spindle a free travel distance, and further comprising:
a handle coupled to an upper end of the post, wherein the handle, the post, the platform and the first number of dividers move as one while the post is slid along the spindle.

18. The developmental robotic manipulation trainer assembly of claim 17, further comprising:
a stop mechanism configured to engage at least one of the post and the spindle after the post has slid the free travel distance along the spindle.

19. The developmental robotic manipulation trainer assembly of claim 17, wherein the post includes an exterior surface that defines a third number of slots that extend at least partially along the elongated length of the post, wherein each slot is configured to receive at least a portion of an inner end of a respective one of the dividers.

20. The developmental robotic manipulation trainer assembly of claim 19, wherein the first number of dividers are removably and slidably coupled to at least one slot on the post, wherein each divider may be slid along a portion of their respective slot and removed therefrom while the handle is coupled to the post.
